(19) United States
(12) Patent Application Publication
(10) Pub. No.: US 2008/0003321 A1
(43) Pub. Date: Jan. 3, 2008

(54) Modular mold system for production of product families

(76) Inventors: George Scott Kerr, Mason, OH (US); Gregory Christopher Peischl, Mason, OH (US); Rainer Armbruster, Wolfach (DE)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/655,348

(22) Filed: Jan. 19, 2007

Related U.S. Application Data
(60) Provisional application No. 60/760,525, filed on Jan. 20, 2006.

(51) Int. Cl. B29C 45/10

(52) U.S. Cl. 425/351

(57) ABSTRACT

The present invention is directed to a modular mold system comprising at least two mold designs or mold sizes. In a further embodiment, the present invention is directed to a modular mold system comprising molds that are the same design but vary in size and cavitation. In a further embodiment, the present invention is directed toward a modular mold system for production of a family of a part designs. In a further embodiment, the present invention is directed toward a modular mold system developed from a part design and a part size. Another embodiment of the present invention would be directed toward a modular mold system comprising at least two mold sizes comprising standardized and identical components.

### CROSS REFERENCE TO RELATED APPLICATIONS

This application claims the benefit of U.S. Provisional application Ser. No. 60/760,525, filed on Jan. 20, 2006.

### FIELD OF THE INVENTION

The present invention relates to an optimized modular injection mold system developed for the production of product family designs or items similar in design but varying in size. This modular mold system comprises multiple mold designs and multiple mold insert designs, both optimized to the part design, the family of item sizes, and the item production needs.

### BACKGROUND OF THE INVENTION

The present invention relates to an optimized modular injection mold system developed for the production of product family designs—or items similar in design but varying in size. This modular mold system comprises multiple mold designs and multiple mold insert designs, both optimized to the item design, the family of item sizes, and the item production needs.

The primary concept of modular molds is to develop and build molds based on the use of standardized components. These molds are primarily used to produce items that are very similar in overall design and dimensions on small cavitation molds. Normally modular molds are based on existing mold designs or sizes or frames. With standard modular mold designs, the use of standardized but changeable mold inserts allows for the introduction of new but very similar designs using existing mold insert designs and standardized mold frame components. These systems have disadvantages in that they are not easily optimized for larger cavitations molds; they have very few common components that can be used in other modular molds without modification. In other words, these modular molds are usually very specialized to produce a specific part design with specific dimensions and not interchangeable with other modular molds or they are so generically designed as to be not efficient in producing items of varying sizes on a large scale i.e. large cavitations molds. In the past, the large scale production of new or unique items requires the utilization of custom designed molds. These dedicated custom molds are designed and constructed to the specific item dimensions, as well as aesthetic and functional characteristics. The size and cavitation of the dedicated custom mold is dictated by both the item design/dimensions and the business/production volume requirements for the item. With the traditional custom mold design, each mold is designed and solely dedicated to a single item design and a single item size. If a family or group of similar items or items of the same design but differing sizes is developed, then traditionally each item design and/or item size requires its own unique custom mold design. This traditional dedicated custom mold system is both very expensive and very time consuming to develop.

Current modular mold systems in use today have been developed to facilitate fast to the market and lower capital costs by utilizing standard or set mold frame designs having interchangeable cavity inserts. These systems have advantages of lower costs and faster mold delivery time. Therefore, these modular systems have been developed and utilized for new item development, small—fast to the market production cycles, or for production of small/limited quantities of similar type items. However, these systems have inherit disadvantages such as the mold designs are not designed and built to be optimal with a specific item design, often insert designs and dimensions are dictated by these existing mold designs and therefore often are not optimal for production of a specific new or unique item. Nor have these current modular mold systems been developed to optimally produce an item on a large scale/on-going basis such as a dedicated custom mold design. Also, the current modular mold systems have not been developed to optimally produce a family or group of items on a large scale basis.

The design and construction of custom molds has been commonly used and the prior used of modular molds has been on a small scale/one time basis in order to get away from the high cost and long development time of dedicated custom molding. However, on a large scale needs basis this has not been achieved i.e. using modular mold/inserts to reduce cost and reduce development time.

However, there is a need for an optimized modular injection mold system developed for the production of product family designs or items similar in design but varying in size.

Accordingly, the present invention is directed to a modular mold system which is designed specifically for the optimized large scale (i.e. high cavitations) production of a product family varying in size. This new modular mold system is entirely developed based on the design/dimensions and functional requirements of the item family. In addition, the present invention's modular system is designed to allow for maximum inter changeability of components within different modular molds with minimum modifications required. This is accomplished by utilizing both multiple mold sizes (cavitation) and insert designs based on the varying item sizes and production volume requirements, with the entire modular system utilizing standardized/interchangeable components to maximize flexibility/efficiency and minimize cost and timing. The overall advantages of this new modular mold system are: Provides high cost saving potential for mold cost; Shortens lead times for mold design/development and construction; Reduces the cost and lead time to implement multi-generational design upgrades; Maximum standardization and interchange-ability; Common spare parts cab be utilized for all molds resulting in additional saving potential; and increases flexibility because of changeable inserts. A further advantage can be seen if the volume of one size goes up, can increase production volume by ordering additional cavities or one may substitute one for the other. For example, the inserts of an eight cavity mold used to produce 200 ml closures could be replaced with eight different inserts used to produce 300 ml closures, the result would be production of 300 ml closures instead of 200 ml closures from a mold that originally was built to produce 200 ml closures. Another advantage is the present invention provides more consistent production quality and through put, wherein for example, two or more separate mold builders can produce with exactly the same mold.

### SUMMARY OF THE INVENTION

The present invention discloses a modular mold system comprising at least two mold designs or mold sizes. In a further embodiment, the present invention is directed to a modular mold system comprising molds that are the same design but vary in size and cavitation. In a further embodiment, the present invention is directed toward a modular mold system for production of a family of a part designs. In a further embodiment, the present invention is directed toward a modular mold system developed from a part design and a part size. Another embodiment of the present invention would be directed toward a modular mold system comprising at least two mold sizes comprising standardized and identical components.

### BRIEF DESCRIPTION OF THE DRAWINGS

While the specification concludes with claims which particularly point out and distinctly claim the invention, it is believed the present invention will be better understood from the following description taken in conjunction with the accompanying drawings.

FIG. 1 is an illustration of a first product family, in particular a product family of caps in an embodiment of the present invention.

FIG. 2 is an illustration of a first product family which are grouped by dimensions and the corresponding multiple insert design based on the family in an embodiment of the present invention.

FIG. 3 is an illustration of mold designs of varying cavitation utilizing common insert, based on Group A of the first product family of FIG. 2 in an embodiment of the present invention.

FIG. 4 is an illustration of mold deigns of varying cavitation utilizing common insert, based on Group B of the first product family of FIG. 2 in an embodiment of the present invention.

FIG. 5 is an illustration of mold deigns of varying cavitation utilizing common insert, based on groups C of the first product family of FIG. 2 in an embodiment of the present invention.

FIG. 6 is an illustration of two sides of a mold, namely the ejector side and the nozzle side in an embodiment of the present invention.

FIG. 7 is an illustration of a cavity insert attached on a nozzle side of a mold in an embodiment of the present invention.

FIG. 8 is an illustration of a nozzle side of a mold design and components of a nozzle side in an embodiment of the present invention.

FIG. 9 is an illustration of an ejector side of a mold design and components of an ejector side in an embodiment of the present invention.

FIG. 10 is an illustration of a product second family, in particular a product second family of caps in an embodiment of the present invention.

FIG. 11 is an illustration of a product second family which have been grouped by dimensions and the corresponding multiple insert design based on the second family in an embodiment of the present invention.

FIG. 12 is an illustration of a first family and a second family in the same mold, using identical molds and identical mold inserts with two different family shapes in an embodiment of the present invention.

FIG. 13 is an illustration of a modular insert for a second family on a nozzle side of a mold in an embodiment of the present invention.

FIG. 14 is an illustration of a Family A and a Family B comprising two different item designs with identical eight cavity molds.

FIG. 15 is an illustration of a Family A and a Family B comprising two different item designs with identical thirty two cavity molds.

### DETAILED DESCRIPTION OF THE INVENTION

While the specification concludes with claims which particularly point out and distinctly claim the invention, it is believed the present invention will be better understood from the following description.

The present invention can comprise, consist of, or consist essentially of the essential elements and limitations of the invention described herein, as well any of the additional or optional ingredients, components, or limitations described herein.

All percentages, parts and ratios are based upon the total weight of the compositions of the present invention, unless otherwise specified. All such weights as they pertain to listed ingredients are based on the active level and, therefore, do not include carriers or by-products that may be included in commercially available materials.

The components and/or steps, including those which may optionally be added, of the various embodiments of the present invention, are described in detail below.

All documents cited are, in relevant part, incorporated herein by reference; the citation of any document is not to be construed as an admission that it is prior art with respect to the present invention.

All ratios are weight ratios unless specifically stated otherwise.

All temperatures are in degrees Celsius, unless specifically stated otherwise.

Except as otherwise noted, all amounts including quantities, percentages, portions, and proportions, are understood to be modified by the word “about”, and amounts are not intended to indicate significant digits.

Except as otherwise noted, the articles “a”, “an”, and “the” mean “one or more” Herein, “comprising” means that other steps and other ingredients which do not affect the end result can be added. This term encompasses the terms “consisting of” and “consisting essentially of”. The compositions and methods/processes of the present invention can comprise, consist of, and consist essentially of the essential elements and limitations of the invention described herein, as well as any of the additional or optional ingredients, components, steps, or limitations described herein.

Herein, “effective” means an amount of a subject active high enough to provide a significant positive modification of the condition to be treated. An effective amount of the subject active will vary with the particular condition being treated, the severity of the condition, the duration of the treatment, the nature of concurrent treatment, and like factors.

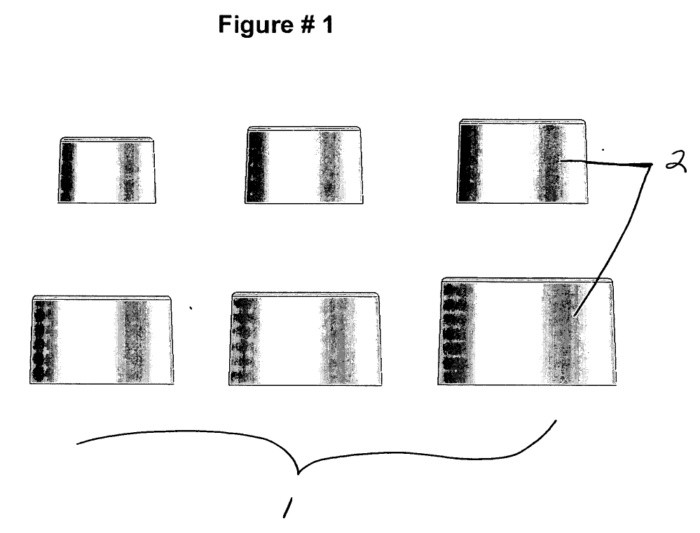

Referring now to FIG. 1, which demonstrates a first product family 1, in particular a product family of caps 2 in an embodiment of the present invention. In another embodiment the product family may include, for example, closures, flip top closures, and bottles.

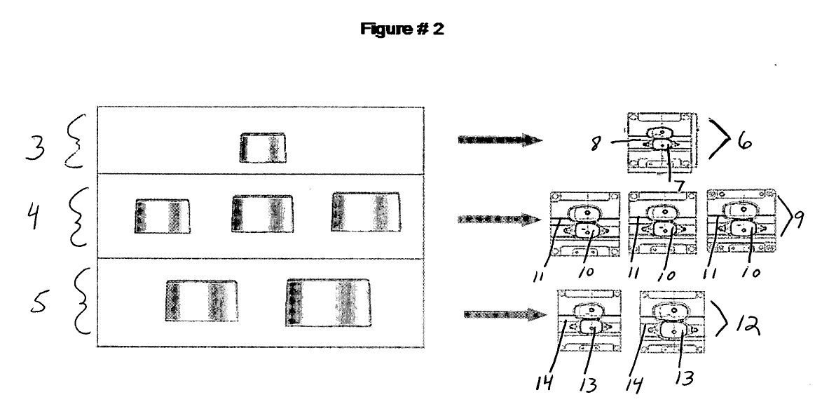

Referring now to FIG. 2, a first product family 1 of FIG. 1, are grouped by dimensions and the corresponding multiple insert design based on the family in an embodiment of the present invention. Group A 3 is the first grouping, based on the dimensions of the cap. Group B 4 comprises the second grouping of three caps based on the dimensions of the cap. Group C 5 is the third grouping of two caps based on the dimensions of the cap. Based on such groups, modular insert 6 is developed corresponding to Group A 3. Further, modular insert 9 is developed corresponding to Group B 4. Further yet, modular insert 12 is developed corresponding to Group C 5. Modular insert 6 includes a cavity insert 7 and a parting line 7. Each of the three modular insert 9 includes a cavity insert 10 and a parting line 11. Each of the three modular insert 9 have the same dimensions. Each of the two modular insert 12 includes a cavity insert 13 and a parting line 14. Each of the two modular insert 12 have the same dimensions.

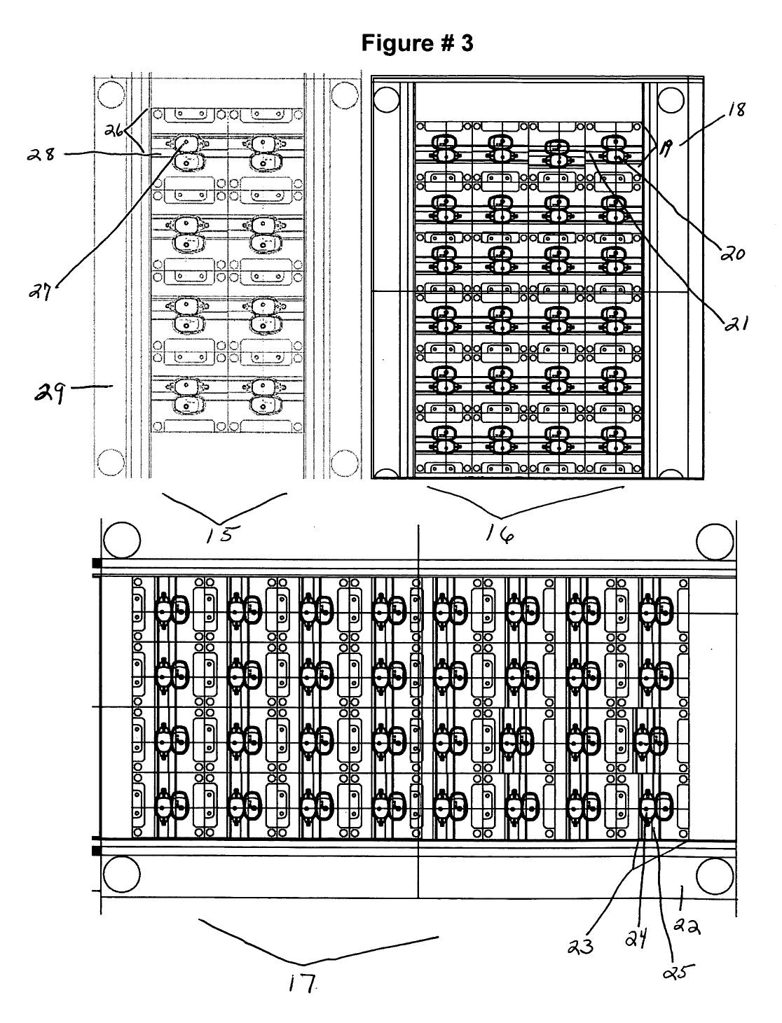

Referring now to FIG. 3, is an illustration of mold designs of varying cavitation utilizing a common insert, based on Group A of the first product family of FIG. 2 in an embodiment of the present invention. An eight cavity mold 15 comprises eight modular inserts 26 and each modular insert 26 comprises a cavity insert 27 and a parting line 28. The eight cavity mold further comprises a mold frame 29. A twenty four cavity mold 16 comprises twenty four modular inserts 19 and each modular insert 19 comprises a cavity insert 20 and a parting line 21. The twenty four cavity mold further comprises a mold frame 18. A thirty two cavity mold 17 comprises thirty two modular inserts 23 and each modular insert 23 comprises a cavity insert 24 and a parting line 25. The thirty two cavity mold 17 further comprises a mold frame 22.

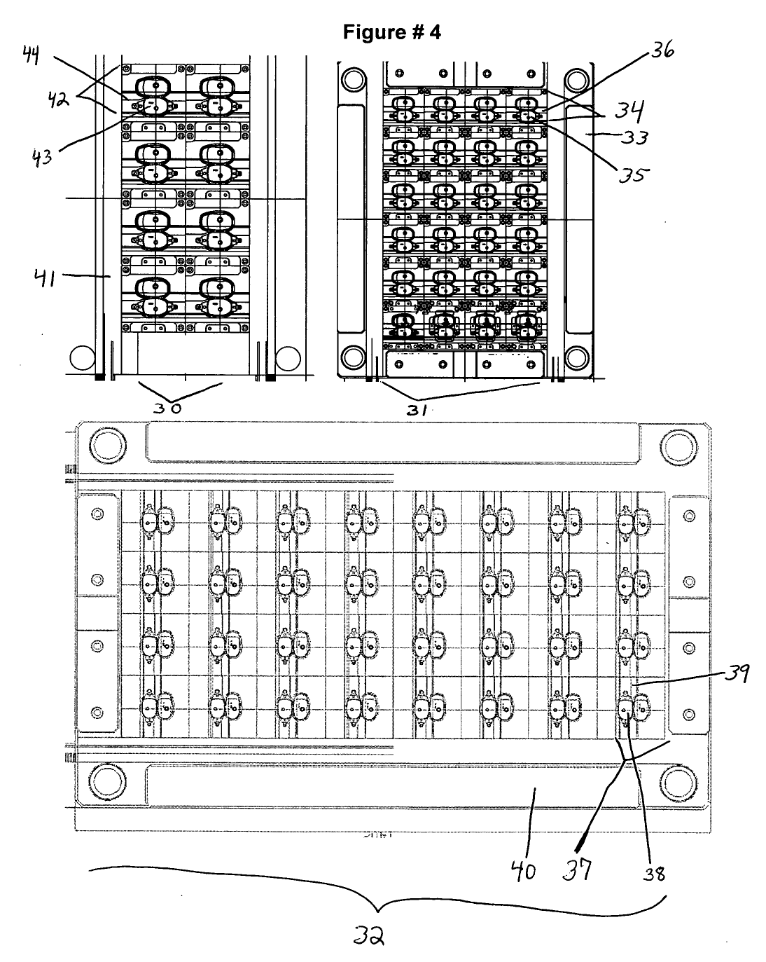

Now referring to FIG. 4, which is an illustration of mold designs of varying cavitation utilizing a common insert, based on Group B of the first product family of FIG. 2 in an embodiment of the present invention. An eight cavity mold 30 comprises eight modular inserts 42 and each modular insert 42 comprises a cavity insert 43 and a parting line 44. The eight cavity mold further comprises a mold frame 41. A twenty four cavity mold 31 comprises twenty four modular inserts 34 and each modular insert 34 comprises a cavity insert 35 and a parting line 36. The twenty four cavity mold further comprises a mold frame 33. A thirty two cavity mold 32 comprises thirty two modular inserts 37 and each modular insert 37 comprises a cavity insert 38 and a parting line 39. The thirty two cavity mold 17 further comprises a mold frame 40. Each of these molds demonstrate a different cavitation and further illustrate a different part size for each of the three caps of Group B 4.

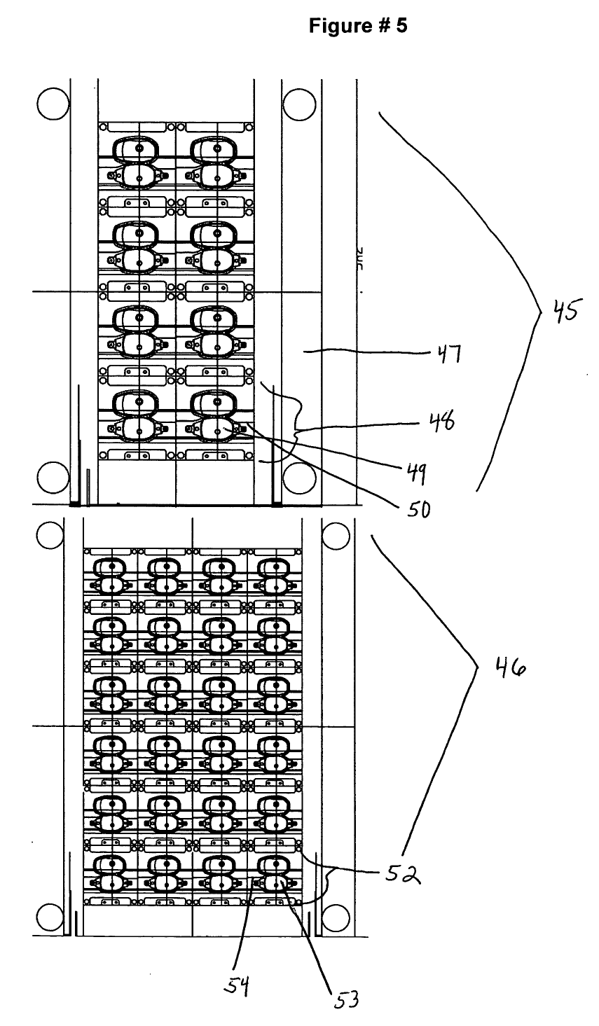

Now referring to FIG. 5, which is an illustration of mold designs of varying cavitation utilizing a common insert, based on Group C of the first product family of FIG. 2 in an embodiment of the present invention. An eight cavity mold 45 comprises eight modular inserts 48 and each modular insert 49 comprises a cavity insert 43 and a parting line 50. The eight cavity mold further comprises a mold frame 47. A twenty four cavity mold 46 comprises twenty four modular inserts 52 and each modular insert 52 comprises a cavity insert 53 and a parting line 54. The twenty four cavity mold further comprises a mold frame 51. Each of these molds demonstrate a different cavitation and further illustrate a different part size for each of the two caps of Group C 5.

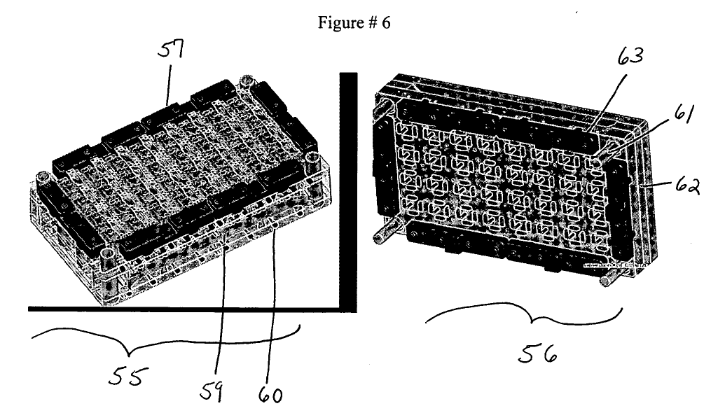

Now referring to FIG. 6, which is an illustration of two sides of a mold, namely the ejector side 55 and the nozzle side 56 in an embodiment of the present invention. FIG. 6 illustrate an ejector side 55 and a nozzle side 56 with no modular inserts depicted. The ejector side 55 comprises mounting blocks 57, pins 58, mounting plate 59, and mold frame 60. The nozzle side 56 comprises pins 61, molding plates 62, and mounting blocks 63. FIG. 6 demonstrates the common components on both sides of the mold, either the ejector side or the nozzle side.

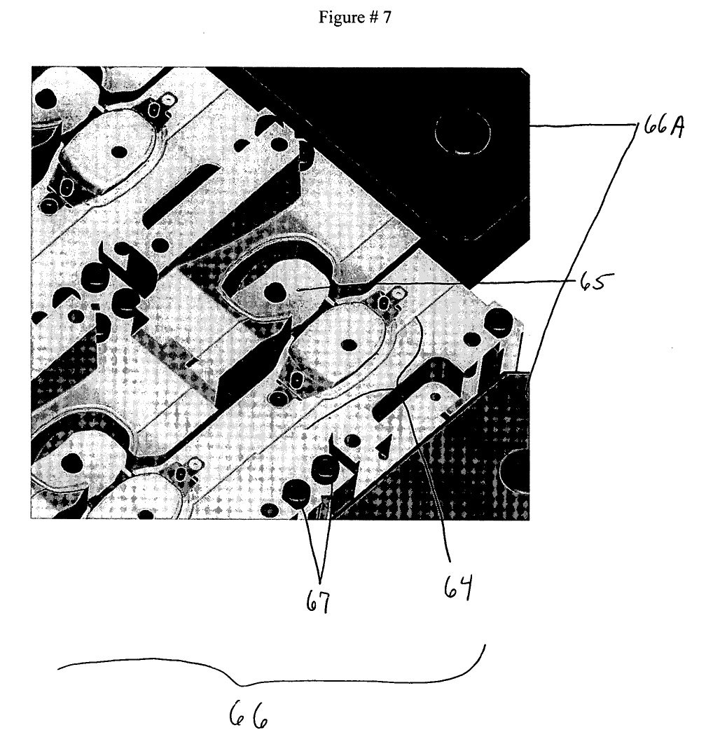

Now referring to FIG. 7, which is an illustration of modular inserts 64 attached on a nozzle side 66 of a mold in an embodiment of the present invention. The modular insert 64 comprises a cavity 65 and bolts 67. FIG. 6 also depicts mounting blocks 66A to which the modular insert 64 are attached. The modular inserts 64 are all the same size. The shape giving area of the modular insert 64 will vary for each part size of a product family.

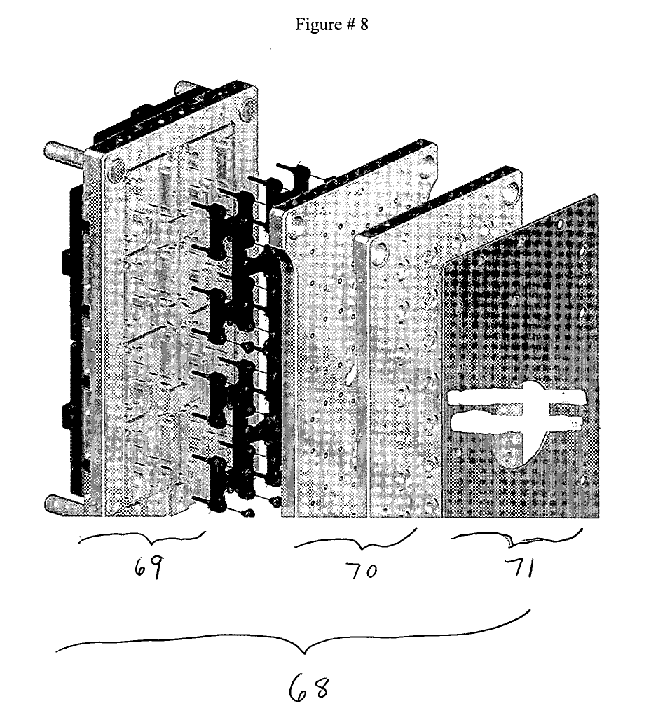

Now referring to FIG. 8, which is an illustration of a nozzle side 68 of a mold design and components of a nozzle side 68 in an embodiment of the present invention. The nozzle side 68 comprises a mold frame 69, buildup plates 70 and mounting plate 71. Each of the components on the nozzle side 68 depicted can be used identically in the modular mold. Therefore, each of the component of the nozzle side 68 can be used interchangeably in the mold.

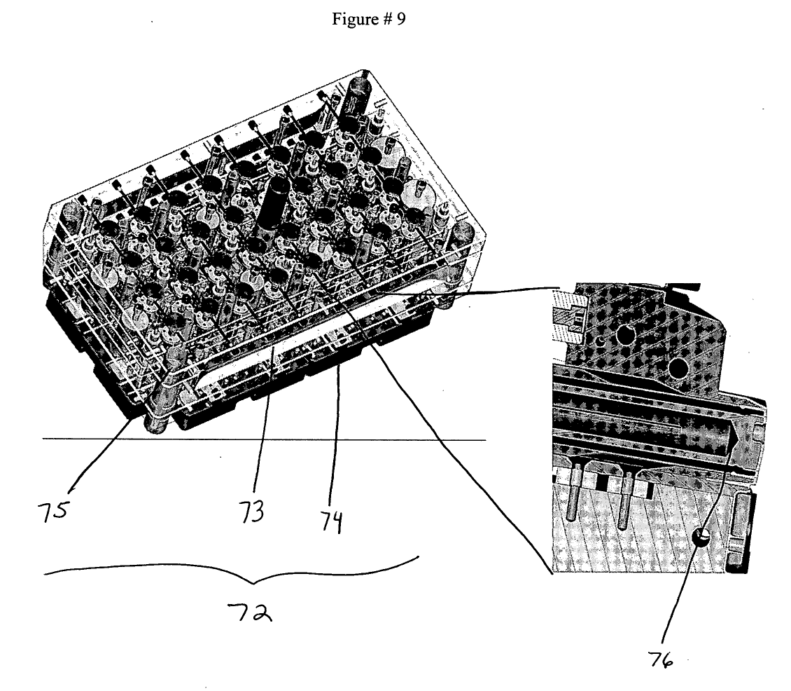

Now referring to FIG. 9, which is an illustration of an ejector side 72 of a mold design and components of an ejector side in an embodiment of the present invention. The ejector side 72 comprises mold plates 73, a mold frame 74 and pins 75. The length of the forced ejection system 76 will be modified in length depending on the part size of a product family. The length of the forced ejection system 76 will be modified dependent on the part size of the product family, but the shape will remain the same.

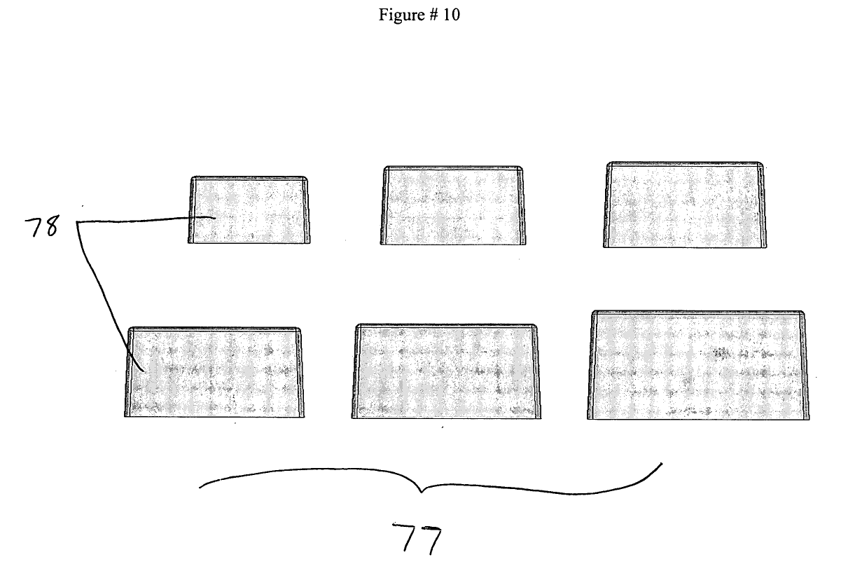

Now referring to FIG. 10, which is an illustration of a product second family 77, in particular a product second family of caps 78 in an embodiment of the present invention. In another embodiment the product family may include, for example, closures, flip top closures, and bottles.

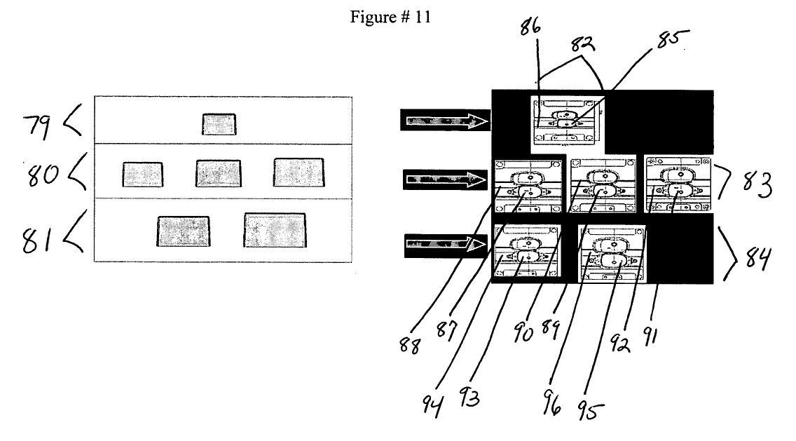

Now referring to FIG. 11, which is an illustration of a first product family 1 of FIG. 10, are grouped by dimensions and the corresponding multiple insert design based on the family in an embodiment of the present invention. Group D 79 is the first grouping, based on the dimensions of the cap. Group E 80 comprises the second grouping of three caps based on the dimensions of the cap. Group F 81 is the third grouping of two caps based on the dimensions of the cap. Based on such groups, modular insert 82 is developed corresponding to Group D 79. Further, modular insert 83 is developed corresponding to Group E 80. Further yet, modular insert 84 is developed corresponding to Group F 81. Modular insert 82 includes a cavity insert 85 and a parting line 86. Each of the three modular insert 83 includes a cavity insert 87, cavity insert 89 and cavity insert 91 and a parting line 88, a parting line 90, and parting line 92. Each of the three modular insert 83 have the same dimensions. Each of the two modular insert 84 includes a cavity insert 93, cavity insert 95 and a parting line 94 and parting line 96. Each of the two modular insert 84 have the same dimensions.

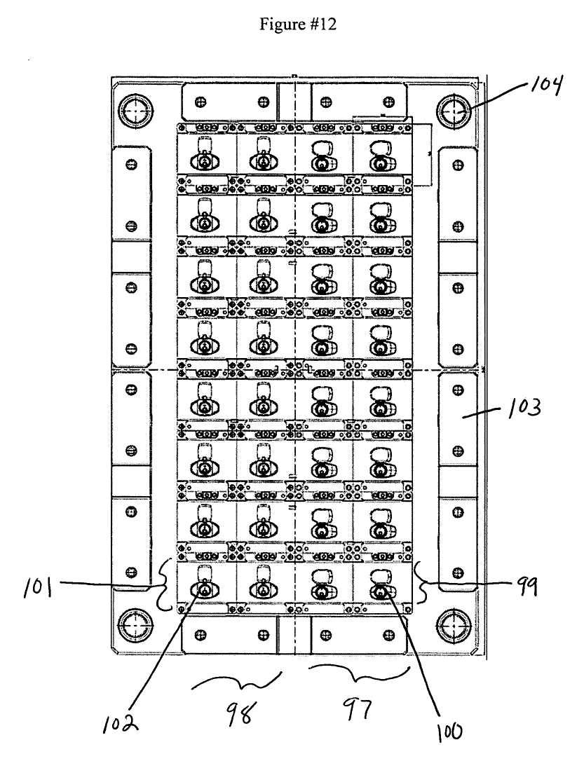

Now referring to FIG. 12, which is an illustration of a first family 97 and a second family 98 in the same mold, using identical molds and identical mold inserts with two different family shapes in an embodiment of the present invention. First family 97 comprises modular inserts 99 and cavity inserts 100. The second family 98 comprises modular inserts 101 and cavity inserts 101. The modular mold comprises mounting blocks 103 and pins 104. The present invention provides for a modular mold that can comprise a first family 97 and a second family 98 wherein they are able to use identical molds and identical modular inserts with two different family shapes. Therefore, the present invention provides the use of an identical modular mold which may be used for more than 1 family.

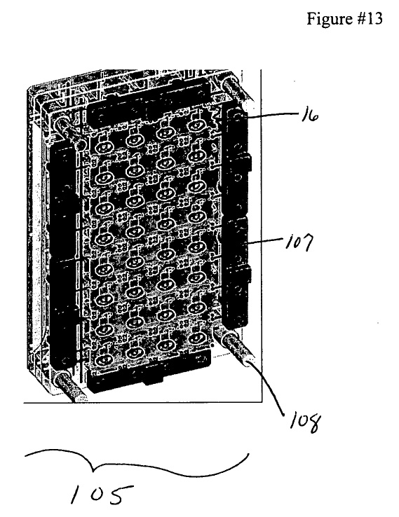

Now referring to FIG. 13, which is an illustration of a modular insert 106 for a second family on a nozzle side 105 of a mold in an embodiment of the present invention. The nozzle side 105 comprises mounting blocks 107 and pins 61. In an embodiment of the present invention, the modular mold system provides the capability for handling more than one family of products wherein the inserts for each family, such as modular insert 106 for a second family, are identical and have the same function and the same dimension.

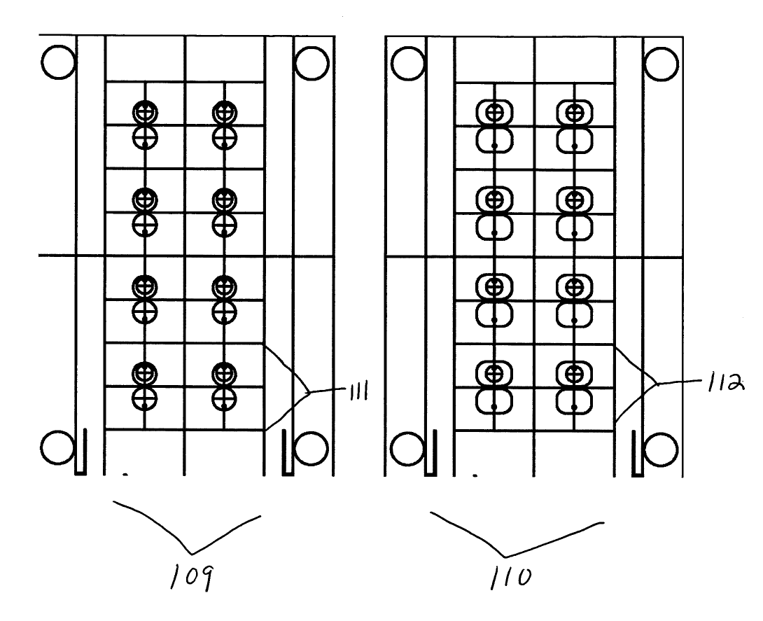

Now referring to FIG. 14, which is an illustration two eight cavity modular mold designs having a Family A 109 and A Family B 110. Family A 109 comprises a cavity insert 111 and Family B 110 comprises a cavity insert 112.

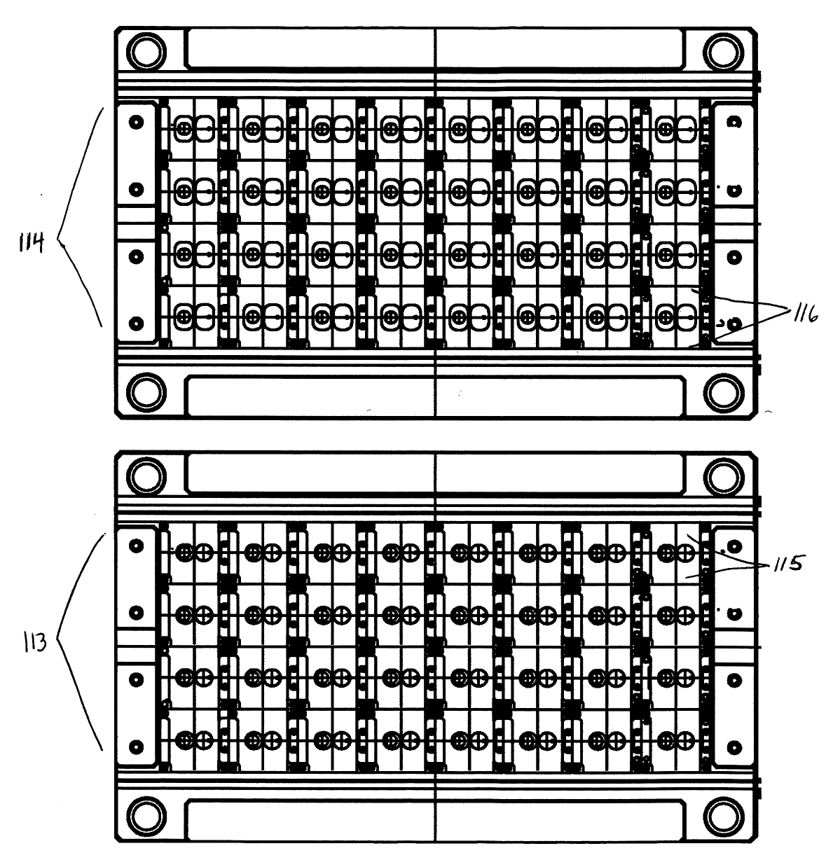

Now referring to FIG. 15, which is an illustration two thirty two cavity modular mold designs having a Family A 113 and A Family B 114. Family A 113 comprises a cavity inserts 115 and Family B 114 comprises a cavity inserts 116.

In an embodiment of the present invention, a modular mold system can provide parts for a product family. A family may include, while not meant to be limiting, a line, type, group, line up, collection, set, assembly, array, arrangement, series, range or assortment.

An embodiment of the present invention is directed a modular mold system which is designed specifically for the optimized large scale (i.e. high cavitations) production of a product family varying in size.

A further embodiment of the present invention is directed to a modular mold system for production of product family designs or items similar in design but varying in size.

Another embodiment of the present invention is directed to a modular mold system designed for the large scale production of a family of part designs.

A further embodiment is directed to a modular mold system entirely developed based on the actual part design(s) and sizes.

In another embodiment, the present invention is direct to a modular mold system comprised of multiple mold sizes based on part size design containing standardized components such as mold mounting blocks, cooling systems, ejector systems, etc.

In an embodiment of the present invention, it is directed to a modular mold system comprised of multiple mold sizes each having multiple mold cavity insert designs for each specific part design and/or part size. In an embodiment of the present invention, while not meant to be limiting, a multiple mold may include at least 2 mold designs or mold sizes.

In yet a further embodiment, the present invention is directed to a modular system designed to allow for maximum interchangeability of components within different modular molds with minimum modifications required.

In an embodiment of the present invention, without being bound by theory, there may be a process of the systematic grouping of the item family into groups based on similar overall dimensions and production needs. This is followed by the development of an insert design for each product group designed for the production of each item in a particular product group. The insert designs in each product group has set dimensions—yet are optimized for the production of the entire group of products. This is followed by the development of multiple mold designs and sizes (cavitations) based on the insert designs and production needs. The mold designs within each product group will have identical components with only the ejector length varying with item size. The mold designs for the entire family (all groups) will have both similar and identical parts. A further embodiment is the ability to utilize the entire mold family to produce additional item family(s) with only minor modifications to the ejector system required.

This is accomplished by designing a group of modular inserts to efficiently produce the part family, then designing multiple molds of varying cavitations by simply varying the number inserts per mold. As a result, multiple mold designs of varying cavitations all share common components, the primary difference between molds being the multiple of inserts used per mold. In an embodiment, this may be based on business needs.

In another embodiment, the present invention is directed to a modular mold system utilizing a combination of multiple mold sizes and cavitations, in combination with multiple insert designs—all based on the varying part sizes and production volume requirements—with the entire modular system utilizing standardized and/or identical and/or interchangeable components to maximize flexibility.

In a further embodiment, the present invention is direct to a modular mold system comprising multiple mold sizes and cavitations in combination with multiple inserts all having common components and therefore maximum interchange ability and production flexibility.

In another embodiment, the present invention is directed to a modular mold system comprised of multiple mold designs and/or sizes and multiple mold insert designs and/or sizes utilizing a common injection point in all molds using identical insert sizes, but allows the injection position on the part to vary as the part size varies.

In a further embodiment, the present invention is directed to a modular mold system comprising multiple mold sizes and cavitations in combination with multiple inserts wherein each insert has a unique cooling based on part design and size.

In a further embodiment, the present invention is directed to a modular mold system comprised of multiple mold sizes and cavitations in combination with multiple inserts where all inserts have unique or optimized cooling based on part design and size.

In another embodiment, the present invention is directed to a modular mold system comprising multiple mold designs/sizes and multiple mold insert designs/sizes having common components and therefore maximum interchangability and production flexibility.

In yet, a further embodiment, the present invention is directed to a modular mold system comprising multiple mold sizes and cavitations in combination with multiple inserts all having standardized and/or identical and/or common components such as standard hot-runner system, standard cavity distance, standard ejection system 1-stage/2-stage, standard mold-insert centerings, standard plate dimensions for mold build-up, standard water, air, hydraulic connections, standard limit switch connections, standard basic insert dimensions, standard insert fixing on mold plates, standard plug configuration boxes and mixtures thereof.

In an embodiment, the present invention is directed to a modular mold system comprising multiple mold sizes and cavitations in combination with multiple inserts on in-mold closing system.

In a further embodiment, the present invention is direct to a modular mold system comprising multiple mold sizes and cavitations in combination with multiple inserts utilizing a common in-mold closing system. Such a modular mold system allows for in-mold closing system to have all common design and components.

In yet a further embodiment, the present invention is directed to a modular mold system comprising multiple mold designs and/or sizes and multiple mold insert designs/sizes being utilized to produce a family of part designs and/or sizes all having a moving part or hinged part.

In another embodiment, the present invention is directed to a modular mold system comprising multiple mold designs/sizes and multiple mold insert designs/sizes all utilizing a specific/special coating to allow for production of high clarity/high gloss items or components.

In a further embodiment, the present invention is directed to a modular mold system comprising multiple mold designs/sizes and multiple mold insert designs/sizes utilizing a changeable injector sleeve system in combination with a pneumatic injector system to aid in the production.

In yet a further embodiment, the present invention is directed to a modular mold system comprising multiple mold designs and/or sizes and multiple mold insert designs and/or sizes used to produce a family of asymmetrical part shapes.

In a further embodiment of the present invention, the modular mold system may comprise a hydraulic device a one end of the mold system which controls a series of vertical arms which are connected to horizontal rails and close the part being molded.

Injection molding, commonly known in the art, is a repetitive on-going process in which melted (plasticized) plastic resin (usually from small beads) is forcefully injected into a mold cavity or cavities. The injected plastic is held in the mold under pressure until it is removed in a solid state, essentially duplicating the cavity shape of the mold. The mold may consist of a single or multiple cavities, each connected to flow channels called runners which direct the flow of the melted plastic to the individual cavities. There are three basic operations: 1. Heating the plastic in the injection machine (press) to allow it to flow under pressure, 2. Injection of the melted plastic into the mold (cavities) and allowing it to harden (cool) in the shape of the cavity under pressure; 3. And opening of the mold halves and ejection of the part from the mold.

In the extrusion blow molding process, commonly known in the art as well, a molten film tube, known as the parison, is extruded and then either taken up by the blow mold or placed inside the mold. Once in the mold, the parison is inflated either by a blowing mandrel (see diagram) or by means of a needle inserted into it. This forces the melt out against the cavity wall, where it cools down, allowing the molded part to be removed from the mold.

In an embodiment of the present invention, and not intended to be limiting, the modular mold system is selected from the group consisting of modular injection mold system, a modular extrusion blow mold system, a modular thermoforming mold system, and a modular compression mold system, or mixtures thereof. In a further embodiment, the modular mold system is a modular injection mold system.

### EXAMPLES

The following examples further describe and demonstrate the preferred embodiments within the scope of the present invention. The examples are given solely for the purpose of illustration, and are not to be construed as limitations of the present invention since many variations thereof are possible without departing from its scope Table 1 below is an embodiment of the present invention, further illustrating some benefits of the present invention's modular mold system:

TABLE 1

| | | | Optimized |
|---|---|---|---|
| | Conventional | Current | Modular Mold |
| Attribute | Molds | Modular Molds | System |
| Components | Low Benefit | Low Benefit | High Benefit |
| which can | | | |
| be used for | | | |
| other molds | | | |
| without | | | |
| modification | | | |
| e.g: mold | | | |
| plates | | | |
| Mold | Unique | Unique for each | Most flexible - both |
| design(s) | for each | design - mold | multiple mold |
| | part size/ | inserts very | designs and |
| | design | similar | multiple mold |
| | | | inserts based on |
| | | | family of part |
| | | | designs. |
| Size/design | NA | Must be Identical | Mold system |
| of mold | | or very similar | designed to |
| insert | | | optimize the insert |
| | | | based on part design |
| | | | and family of |
| | | | designs. |
| Size | | Generally fixed | Fixed in design |
| of mold | | | stage of the part(s) |
| | | | to be produced |
| Shape and | NA | Must be identical | Must be similar - |
| part design | | or very similar. | but mold system is |
| | | | designed to allow |
| | | | more variability in |
| | | | size to deliver |
| | | | family of design. |
| Part size | | Must be similar | Different - Mold |
| | | | system designed to |
| | | | allow for variability |
| | | | in size. |
| Saving | Low | Med-High | Very high (if many |
| potential | Benefit | | part sizes will be |
| | | | used in one modular |
| | | | mold system) |

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A modular mold system comprising at least two mold designs or mold sizes.

2. A modular mold system according to claim 1 comprising molds that are the same design but vary in size and cavitation.

3. A modular mold system according to claim 1 wherein the modular mold system for production of a family of a part designs.

4. A modular mold system according to claim 1 developed from a part design and a part size.

5. A modular mold system according to claim 1 comprising at least two mold sizes comprising standardized and identical components.

6. A modular mold system according to claim 5 wherein the standardized and identical components are selected from the group consisting of a mold mounting block, a cooling system, an ejector system, a hot runner system, a cavity distance, a plate dimension for mold build-up, a water connection, an air connection, a hydraulic connection, a limit switch connection, a basic insert connection, a plug configuration box and mixtures thereof.

7. A modular mold system according to claim 1 comprising at least two mold sizes each having a at least two mold cavity insert designs.

8. A modular mold system according to claim 1 wherein the said mold cavity insert designs comprises identical dimensions and design s for each mold group.

9. A modular mold system according to claim 1 comprising at least two mold sizes and at least two cavitations in combination with at least two modular mold insert designs wherein the modular mold system utilizes standardized and identical components which are interchangeable.

10. A modular mold system according to claim 1 comprising at least two mold sizes and at least two cavitations in combination with at least two inserts each insert comprising identical components.

11. A modular mold system according to claim 1 wherein the modular inserts are centered and fixed directly onto the mold plate without requiring the use of a cavity pocket.

12. A modular mold system according to claim 1 comprising at least two mold designs and molds sizes comprising a fixed injection point in each mold comprising identical insert sizes.

13. A modular mold system according to claim 12 wherein the fixed injection point within a mold design results in a variable injection point on a part which is dependent on a part size.

14. A modular mold system according to claim 1 comprising more at least two cavity inserts which are interchangeable comprising a cooling system according to the item size and item shape.

15. A modular mold system comprising at least two mold sizes or mold shapes further comprising at least two cavitations in combination with at least two multiple inserts having components selected from the group consisting of a mold mounting block, a cooling system, an ejector system, a hot runner system, a cavity distance, a plate dimension for mold build-up, a water connection, an air connection, a hydraulic connection, a limit switch connection, a basic insert connection, a plug configuration box and mixtures thereof.

16. A modular mold system according to claim 1 wherein the modular mold system comprises an in-mold closing system.

17. A modular mold system according to claim 16 wherein the modular mold system allows for an in-mold closing system to have all common design and identical components.

18. A modular mold system according to claim 1 wherein the modular mold system produces a family of designs or sizes each having a movable part.

19. A modular mold system according to claim 15 wherein the movable part is a hinged part.

20. A modular mold system according to claim 1 wherein the modular mold system comprises a changeable injector sleeve system in combination with a pneumatic injection system.

21. A modular mold system according to claim 1 wherein the modular mold system produces a family of asymmetrical items or asymmetrical shapes.

22. A modular mold system according to claim 1 wherein the modular mold system is selected from the group consisting of a modular injection mold system, a modular extrusion blow mold system, a modular thermoforming mold system, and a modular compression mold system, or mixtures thereof.

23. A modular mold system according to claim 1 wherein the modular mold system is a modular injection mold system.

24. A modular mold system according to claim 1 wherein each of the components on a nozzle side of a group of molds are identical.

25. A modular mold system according to claim 1 wherein each of the components on an ejector side of a group of molds are identical according to the item size and item design wherein an ejector length will vary according to the item size and item design.

26. A modular mold system according to claim 1 wherein the use of an identical modular mold may be used for more than one family.

27. A modular mold system according to claim 26 comprising more than 1 mold insert being identical in a design and a dimension as used in a different family.

28. A modular mold system according to claim 1 comprising a multiple component molding system.

29. A modular mold system according to claim 28 comprising a multiple material molding system.
